(19) United States
(12) Patent Application Publication
(10) Pub. No.: US 2017/0187815 A1
(43) Pub. Date: Jun. 29, 2017

(54) INDOOR DEVICE CONTROL ASSISTANCE

(71) Applicant: Intel Corporation, Santa Clara, CA (US)

(72) Inventors: Oded Vainas, Petah Tiqwa (IL); Omri Mendels, Tel Aviv (IL); Ronen Soffer, Tel Aviv (IL)

(21) Appl. No.: 15/280,058

(22) Filed: Sep. 29, 2016

(30) Foreign Application Priority Data
Dec. 24, 2015 (US) PCT/US2015/000438

(51) Int. Cl. H04L 29/08; H04W 4/02; H04L 12/26

(52) U.S. Cl. CPC H04L 67/22; H04L 67/12; H04L 67/306; H04L 43/04; H04W 4/023; H04W 88/02

(57) ABSTRACT

Apparatus, systems, and/or methods may provide control assistance. For example, a mobile device on a user may provide sensor data for the user. In addition, a routine may be determined based on the sensor data from the mobile device and/or sensor data from one or more indoor devices on premises. Moreover, an action of an indoor device may be defined based on the sensor data from the mobile device and/or the sensor data from the one or more indoor devices. The action may include a predicted action, which may be suggested to the user and/or automatically executed, via control data, by the indoor devices. Additionally, control assistance may be provided to a plurality of users.

### CROSS-REFERENCE TO RELATED APPLICATIONS

The present application claims the benefit of priority to International Patent Application No. PCT/US2015/000438 filed on Dec. 24, 2015.

### TECHNICAL FIELD

Embodiments generally relate to control assistance. More particularly, embodiments relate to indoor device control assistance based on sensor data from a mobile device, sensor data from an indoor device, a routine, and/or a predicted action.

### BACKGROUND

Automation of indoor devices, such as appliances, may be achieved by programming the indoor devices. A user, however, may waste time programming the indoor device, and/or may experience frequent inconvenience when conditions frequently change. Automation may also be achieved using data that involves only indoor usage, from indoor sensors that are fixed to premises, and/or that is not specific for particular user contexts. In this case, incorrect automation may cause waste of user time, user inconvenience, waste of resources (e.g., computing resources, natural resources, etc.), and so on. Thus, there is considerable room for improvement to provide automation of indoor devices that saves user time, saves resources, etc.

### BRIEF DESCRIPTION OF THE DRAWINGS

The various advantages of embodiments will become apparent to one skilled in the art by reading the following specification and appended claims, and by referencing the following drawings, in which:

FIG. 1 is an example of a system to provide control assistance according to an embodiment;

FIG. 2 is an example of an apparatus to provide control assistance according to an embodiment;

FIG. 3 is a flowchart of an example of a method to provide control assistance according to an embodiment; and

FIG. 4 is a block diagram of an example of a computing device according to an embodiment.

### DESCRIPTION OF EMBODIMENTS

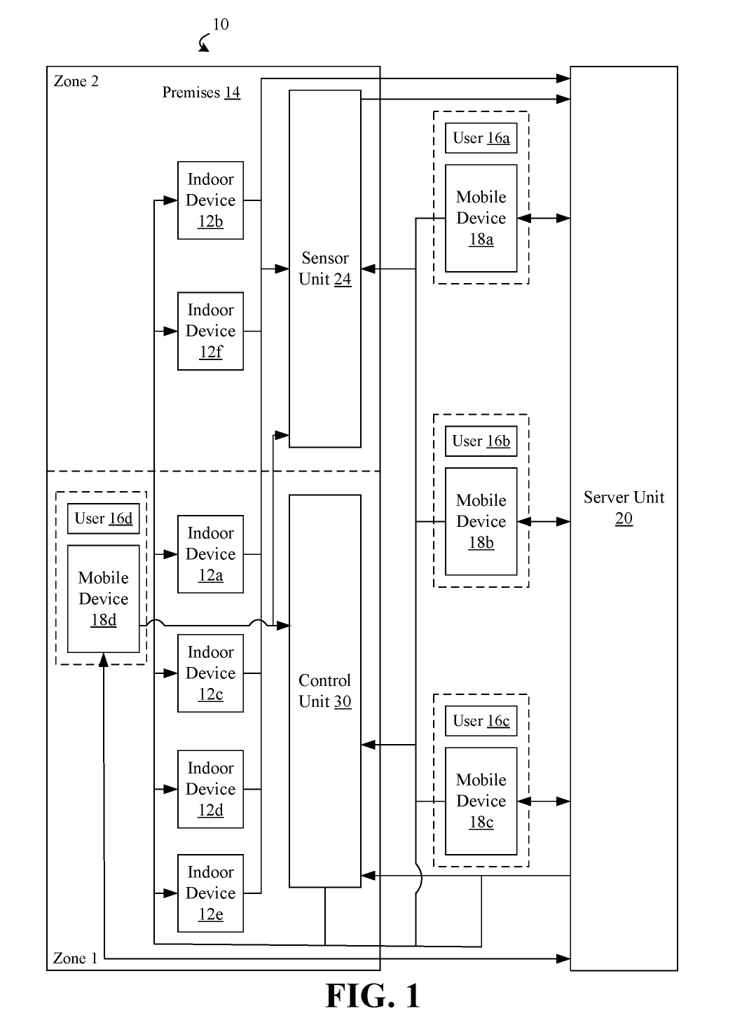

FIG. 1 illustrates an example of a control assistance system 10 according to an embodiment, in which sensor data is utilized to define an action of one or more indoor devices 12 (12a-12f) on premises 14. The premises 14 may include any structure such as, for example, a commercial structure (e.g., a restaurant, a supermarket, an office building, a gymnasium, a stadium, etc.), a residential structure (e.g., a house, a condominium, etc.), a parking structure (e.g., a commercial parking garage, a residential parking garage, etc.), and so on. In the illustrated example, the premises 14 is a residence (e.g., home) of users 18 (18a-18d) (e.g., habitants).

The indoor devices 12 may include appliances such as, for example, cooking appliances (e.g., stove, blender, drink maker, etc.), storage appliances (e.g., refrigerator, etc.), cleaning appliances (e.g., washer, drier, etc.), detectors (e.g., smoke detectors, etc.) and so on. The indoor devices 12 may also include systems and/or components of systems, such as heating, ventilation, and air condition (HVAC) systems, fixture systems (e.g., recessed lights, lamps, window shades, window blinds, etc.), plumbing systems (e.g., water heaters, valves, etc.), entertainment systems (e.g., smart TV, audio system, etc.) and so on. The indoor devices 12 may also include an Internet of Things (IoT) device, which may be a fixed-function indoor device having sensors to generate sensor data indicating current conditions in a deployment environment and/or a current state of the IoT device. In addition, the IoT device may include communication functionality to communicate the sensor data.

In the illustrated example, the indoor device 12a is a first thermostat, the indoor device 12b is a second thermostat, the indoor device 12c is foyer lighting, the indoor device 12d is a cloths washer machine, the indoor device 12e is a hot water heater, and the indoor device 12f is a shower valve. Thus, the indoor devices 12 may generate sensor data indicating current conditions of the premises 14 (e.g., temperature, etc.) and/or current states of the indoor devices 12 (e.g., on, etc.). The sensor data may include, for example, light data, temperature data, humidity data, fixture movement data, noise data, occupancy data, indoor device use data, etc.

Sensor data may be also be generated by one or more mobile devices 18 (18a-18d). The mobile devices 18 may include, for example, a notebook computer, a tablet computer, a convertible tablet, a personal digital assistant (PDA), a mobile Internet device (MID), a media player, a smart phone, a radio, a wearable device (e.g., smart watch), a hand-held gaming console, and so on. Thus, the mobile devices 18 may be mobile computing platforms that do not require specific purpose sensor hardware that may be required in, for example, IoT devices, specific purpose devices, and so on. Moreover, the form factor of the mobile devices 18 may be user specified since the users 16 may specify which devices participate in the system 10, since the users 16 may specify which sensors participate in the system 10, since the users 16 may utilize any type of mobile device with one or more sensors, and so on.

The mobile devices 18 may also have communication functionality such as wireless communication functionality including, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), 4G LTE (Fourth Generation Long Term Evolution), Bluetooth (e.g., Institute of Electrical and Electronics Engineers/IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF). Thus, for example, the mobile devices 18 may communicate sensor data indicating a current state of the users 16.

In the illustrated example, the mobile device 18a is a smart watch that is on the user 18a (e.g., worn) and provides sensor data for the user 16a, the mobile device 18b is a mobile phone that is on the user 16b (e.g., held in a pocket, held in a hand, etc.) and provides sensor data for the user 16b, the mobile device 18c is a smart ring that is on the user 18c (e.g., worn) and provides sensor data for the user 16c, and the mobile device 18d is a tablet on the user 16d (e.g., held in a pocket, held in a hand, etc.) and provides sensor data for the user 16d. Thus, the sensor data may include, for example, location data for a user, voice detection data for a user, heart rate data for a user, pulse data for a user, temperature data for a user, transportation data for a user, call data for a user, and so on.

The type of sensor data may change dynamically based on the location of the users 16 relative to the premises 14. For example, the sensor data may include outdoor sensor data for a user. In the illustrated example, the mobile devices 18a-18c generate outdoor sensor data for the users 16a-16c, respectively, that are each off the premises 14. In addition, the sensor data may include indoor sensor data for a user. In the illustrated example, the mobile device 18d generates indoor sensor data for the user 16d that is on the premises 14. The type of sensor data generated may, however, automatically and dynamically change when the users 16a-16c enter the premises 14 (e.g., from outdoor sensor data to indoor sensor data), when the user 16d leaves the premises 14, and so on. In addition, transitions between types of sensor data may be smooth (e.g., without breaks), transparent to the users 16, etc.

The type of sensor data may also automatically and dynamically change based on the location of the indoor devices 12, the users 16, and/or the mobile devices 18 relative to each other. For example, the user 16d may place the mobile device 18d down and walk in a direction from the indoor device 12a to the indoor device 12b without the mobile device 18d. In this case, the sensor data from the indoor devices 12a, 12b, alone or in together, may generate sensor data for the premises 14 (e.g., temperature, etc.) and for the user 16d (e.g., user location based on temperature changes, etc.). In addition, the mobile device 18d may begin and/or continue to generate sensor data for the premises 14 when it is placed down. Similarly, the mobile device 18d may generate sensor data for the premises 14 (e.g., light intensity, temperature, etc.) and sensor data for the user 16d (e.g., acceleration, location data, etc.) when the user 16d walks within the premises 14 with the mobile device 18d.

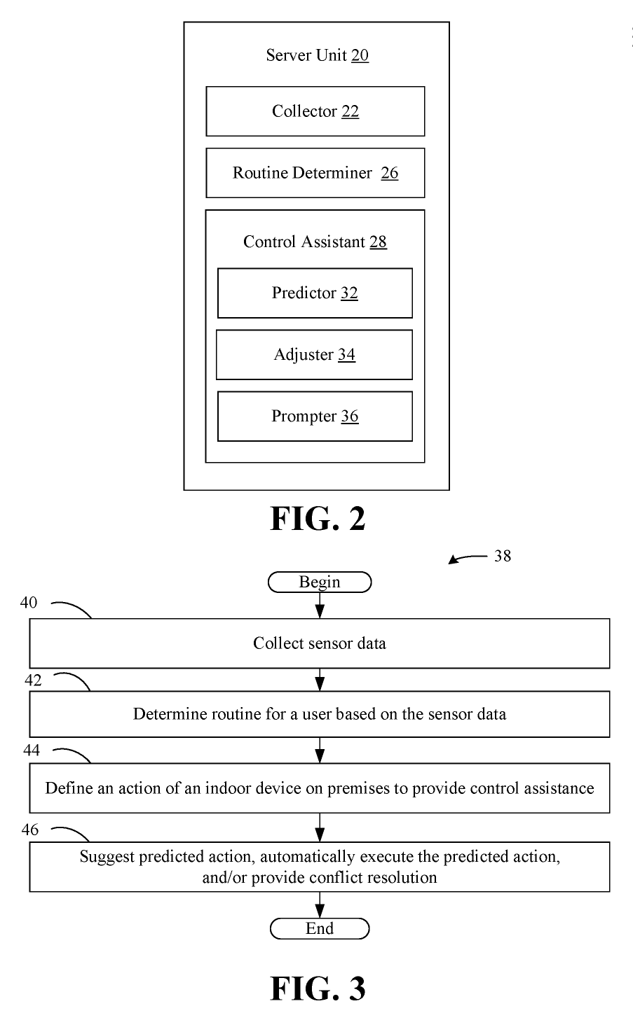

The sensor data may be provided to a server unit 20, continuously and/or periodically, to provide control assistance based on the sensor data. The server unit 20 may be off the premises 14, may be on the premises 14, and/or may be distributed on and off the premises 14. In one example, the server unit includes a cloud-computing server. Turning now to FIG. 2, the server unit 20 includes a collector 22 to collect sensor data. As shown in FIGS. 1 and 2, the collector 22 may collect the sensor data directly from the indoor devices 12, directly from the mobile devices 18, and/or directly from a sensor unit 24 coupled with the indoor devices 12 and the mobile devices 18. For example, the sensor unit 24 may be on the premises 14 and may receive, aggregate, and/or forward the sensor data from the indoor devices 12 to the server unit 20. The sensor unit 24 may, however, be off the premises 14 when utilized, be on and off the premises when utilized, and so on.

The server unit 20 further includes a routine determiner 26 to determine a context specific to the users 16 based on the sensor data. For example, the context may include specific activities performed by the users 16. In the illustrated example, the routine determiner 26 may determine that a context specific to the user 16a is “user 16a running outdoors” based on sensor data from mobile device 18a that is on the user 16a such as, for example, accelerometer data, heart rate data, pulse data, light intensity data, image capture data, and so on. In another example, the routine determiner 26 may determine that the context specific to the user 16d is “user 16d sitting in the living room” based on sensor data from the mobile device 18d such as, for example, accelerometer data, location data, image capture data, and so on.

The routine determiner 26 may determine that a context (e.g., running, sitting, etc.) is specific to the users 16 from an association between the users 16 and the mobile devices 18. The association may be determined from a registration process (e.g., a user indicates a specific device is used by a specific user, etc.). The association may also be determined from a machine learning process (e.g., a specific user that uses a specific device has a characteristic feature such as resting heart rate, gait, acceleration, etc.). In addition, the association may be determined from other data such as, for example, security data indicating that a particular user has access to restricted functionality of the indoor devices 12 and/or the mobile devices 18, access to restricted areas of the premises 14, and so on.

Additionally, the routine determiner 26 may determine the association based on spatial changes and/or temporal changes involving sensor data. For example, the routine determiner 26 may determine that the user 16d is walking within the premises 14 based on a change of sensor data from the mobile device 18d (e.g., absence of sensor data for the user, etc.) temporally proximate to a change of sensor data from the indoor devices 12a, 12b (e.g., temperature change, automatic or by user input, etc.). The routine determiner 26 may also determine that the context is specific to the users 16 by process of elimination (e.g., a determination that all habitants but one are outside, and therefore the sensor data is for one habitant, etc.). In addition, the routine determiner 26 may determine that the context is specific to the users 16 by image capture data from an indoor device (e.g., a camera, etc.).

The context specific to the users 16 may be stored at the server unit 20 as routines for the users 16. In one example, the server unit 20 may store an indoor routine for the user 16d that includes sitting in the living room (on a particular day, date, time, etc., for a particular duration, etc.) and walking from a first heating zone 1 (e.g., having a living room) to a second heating zone 2 (e.g., having a bedroom) with a temperature change (e.g., automatic, by user input, etc.). In another example, the server unit 20 may store an outdoor routine for the user 16a that includes running from the premises 14 (e.g., on a particular day, date, time, etc., for a particular duration, along a particular route, etc.) and returning to the premises 14 (e.g., at a particular time, etc.). The server unit 20 may also store a hybrid indoor-outdoor routine, such as a routine for the user 16a that includes an outdoor routine (e.g., running, etc.) and with an indoor routine (e.g., a load of laundry, a shower, etc.).

Notably, the granularity of sensor data and/or of routines may be user specified. For example, the routine determiner 26 may determine an indoor-outdoor routine for the user 16a at a relatively more granular spatial level and/or temporal level, such as, for example, that the user 16a runs for five miles starting at about noon eastern standard time on weekends, starts laundry about fifteen minutes after returning home, and showers for about twenty minutes after starting laundry. Similarly, a type of control assistance, presentation of control assistance, control assistance conflict resolution, control assistance granularity, etc., may be user specified.

Referring back to FIG. 2, the server unit 20 includes a control assistant 28 to provide control assistance, which may define an action of indoor devices to be executed by the indoor devices 12 via control data. As shown in FIGS. 1 and 2, the control data may be provided directly from the control assistant 28, directly from the mobile devices 16, and/or directly from a control unit 30. For example, the control unit 30 may be on the premises 14 and may receive, aggregate, and/or forward control data utilized to execute an action to the indoor devices 12. The control unit 30 may, however, be off the premises 14 when utilized, on and off the premises when utilized, and so on.

The illustrated control assistant 28 includes a predictor 32 to generate a predicted action based on a current state of the users 16, a current state of the premises 14, and/or routines. The predictor 32 may predict, for example, that a user is likely to modulate the temperature of the heating zone 1 and/or the heating zone 2 based on a current state of the premises 14 (e.g., current temperature deviates from an average for a geographic area, etc.). The predictor 32 may also predict that a user is likely to modulate the temperature of the heating zone 1 and/or the heating zone 2 based on a current state of the user (e.g., current temperature deviates from average body temperature, etc.). In either case, a predicted action to be executed by the indoor devices 12a, 12b may involve modulating temperature to an average indoor temperature for a geographic area, modulating temperature to a temperature that will normalize the body temperature to average body temperature, and so on.

Confidence of a predicted action may increase when the predictor 32 uses the current state of the premises 14 together with the current state of the users 16. The confidence of a predicted action may further increase with the addition of a routine specific for the users 16. For example, a predicted action to be executed by the indoor devices 12a, 12b may involve modulating temperature as previously or routinely modulated by a specific user (or groups of users) under a same and/or a similar condition. The confidence of a predicted action may further increase when the granularity of the data used to predict the appropriate action increases. In one example, the predictor 32 may consider a time of day, a date, a specific user, etc., together with a current state of the premises 14 and/or a current state of the users 16.

In another example, a routine for the user 16a may include outdoor running for five miles and for one hour starting at about noon eastern standard time in the fall on weekends, immediately turning off the lights in the foyer and setting the temperature to about 70 degrees in the heating zone 2, starting a load of laundry with hot water about fifteen minutes after returning, and taking a shower with hot water for about twenty minutes after starting laundry. When the user 16a is a predetermined time into the activity and/or a predetermined distance from the premises 14, based on the sensor data from the mobile device 18a, and the premises is 80 degrees, based on the sensor data from the indoor sensors 12a, 12b, the predictor 32 may determine an action based on the indoor-outdoor routine for the user 16a.

The predictor 32 may, for example, predict with relatively high confidence that the indoor device 12b is to be controlled (e.g., change the temperature to 70 degrees), that the indoor device 12c is to be controlled (e.g., power off the foyer lights), that the indoor device 12d is to be controlled (e.g., start drawing hot water into the washer machine), that the indoor device 12e is to be controlled (e.g., ensure sufficient hot water to accommodate laundry and a shower), and/or that the indoor device 12f be controlled (e.g., start shower with hot water). Thus, the predictor 32 may generate predicted actions which when executed via control data control the devices 12.

The action may be binary (e.g., power on, power off, etc.) and/or may be measured (e.g., according to an extent that resources are preferred and/or needed based on activities of users, number of users, etc.). In addition, the predictor 32 may account for the timing of predicted actions (e.g., ensure sufficient hot water about ten minutes before arrival, change temperature about five minutes before arrival, start shower about twenty minutes after arrival, etc.).

The predicted actions may be automatically executed by the indoor devices 12 and/or may be suggested to the users 16 prior to being executed. As shown in FIG. 2, the server 20 includes an adjuster 34 to automatically execute the predicted actions by the indoor devices 12. In one example, predicted actions may always be automatically executed, in part or in whole. In another example, predicted actions that satisfy a confidence threshold level may be automatically executed. For example, predicted actions may be automatically executed where there is a sufficient likelihood that the users 16 would approve and/or implement the predicted actions based on, e.g., a current state of the premises 14, a current state of the users 16, and/or routines for the users 16. The adjuster 34 may forward control data directly to the indoor devices 12 and/or directly to the control unit 30 to cause the indoor devices 12 to execute the predicted actions.

The server 20 further includes a prompter 36 to suggest the predicted actions to the users 16. The prompter 36 may suggest the predicted actions via a user interface of the mobile devices 18. For example, the user interface may include a graphical user interface, an audio user interface, a tactile user interface, and so on. The prompter 36 may suggest the predicted actions by, for example, proactively offering control assistance to the users 16 (e.g., presenting an option, a message such as “Would you like help”, etc.), by responding to a request for control assistance by the users 16 (e.g., responding to a command, a message such as “I would like help”, etc.), by automatically presenting the predicted actions to the users 16 (e.g., sorted based on likelihood, confidence, spatial order, temporal order, etc.), and so on.

The prompter 36 may also suggest the predicted actions to all of the users 16, to a subset of the users 16, and so on. For example, the prompter 36 may suggest the predicted actions to all users that are to be affected, currently or in the future, by the execution of the predicted actions. In addition, the control assistant 28 may resolve conflicts among the users 16 by, for example, defaulting to a current state of master user, defaulting to a routine of a master user, defaulting to a selection by a master user, and so on. The control assistant 28 may also resolve conflicts among the users 16 by, for example, considering voting metrics from the users 16 (e.g., total up or down votes, etc.). The control assistant 28 may provide resolution assistance including, for example, suggesting user conferencing, automatically conferencing users, etc. In addition, the control assistant 28 may resolve conflicts on an action-by-action basis, on a combination-of-actions basis, and so on.

While examples have shown separate components for illustration purposes, it is should be understood that one or more of the components of the system 10 (FIG. 1) and/or the server unit 20 (FIG. 2), discussed above, may reside in the same and/or different physical and/or virtual locations, may be combined, omitted, bypassed, re-arranged, and/or be utilized in any order.

Turning now to FIG. 3, an example of a method 38 to provide control assistance is shown according to an embodiment. The method 38 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 38 may be written in any combination of one or more programming languages, including an object oriented programming language such as C++ or the like and conventional procedural programming languages, such as the “C” programming language or similar programming languages.

Illustrated processing block 40 collects sensor data, which may be for a user, premises, an indoor device, etc. For example, block 40 may collect sensor data from a mobile device on the user, which may include outdoor sensor data for the user from the mobile device when the user is off the premises, may include indoor sensor data for the user from the mobile device when the user is on the premises, may include sensor data for the premises from the mobile device on the premises, and so on. Similarly, sensor data from indoor devices on the premises may be for the user and/or for the premises.

Illustrated processing block 42 determines a routine for the user based on the sensor data. For example, the routine may be based on the sensor data for the user from the mobile device, the sensor data for the user from the indoor devices on the premises, the sensor data for the premises from the mobile device, the sensor data for the premises from the indoor devices, the sensor data for the indoor devices from the indoor devices, and so on. In one example, block 42 may determine a plurality of routines for a plurality of users from sensor data collected from a plurality of indoor devices on the premises. In another example, block 42 may determine a plurality of routines for a plurality of users from sensor data collected from a plurality of mobile devices on the plurality of users.

Accordingly, block 42 may generate one or more routines for one or more users. For example, block 42 may generate a routine including outdoor workout of habitants and arrival to a residence based on sensors from wearable devices and sensors inside the home. Block 42 may also generate a routine including indoor leaving home activities and outdoor leaving building activities (relative to the home), outdoor leaving parking space activities (relative to residential structure), etc. Block 42 may also generate a routine including outdoor prolonged absence activity. Block 42 may further generate a routine including indoor prolonged occupancy activity.

Illustrated processing block 44 may define an action of an indoor device on the premises. The action may be based on, for example, the sensor data from the mobile device, which may include outdoor sensor data for the user from the mobile device, indoor sensor data for the user from the mobile device, and so on. The action may be based on, for example, sensor data for the user and/or the premises from the indoor devices. The action may be based on, for example, the routine for the user, a plurality of routines for the user, a plurality of routines for a plurality of users, etc.

Block 44 may, for example, generate predicted actions based a current state of the user, a current state of the premises, and/or routines of one or more users. Block 44 may generate predicted actions which when executed via control data cause activation of required electrical appliances (e.g., boiler, laundry, etc.) to save time before habitants arrive at home based on an activity and/or a routine including outdoor workout of habitants and arrival to a residence using sensors from wearable devices and sensors inside the home.

Block 44 may also generate predicted actions which when executed via control data cause calling an elevator, warming up a vehicle, notifying an entity (e.g., person, organization, etc.) that the user is about to leave, etc., based on an activity and/or a routine including indoor leaving home activities, outdoor leaving building activities, and so on. Block 44 may further generate predicted actions which when executed via control data cause reduction of electrical consumption, increase of home security, etc., based on an activity and/or a routine including outdoor prolonged absence activity. Block 44 may also generate predicted actions which when executed via control data cause ensuring of heating operating close to a sleep time or a wake up time, turning off lights when leaving a room, etc., based on an activity and/or a routine including indoor prolonged occupancy activity.

Illustrated processing block 46 suggests predicted actions and/or automatically executes the predicted actions. For example, block 46 may suggest predicted actions in response to a prompt for help, in response to a command from a user for help, and so on. In addition, block 46 may automatically execute the predicted actions via control data to the indoor devices based on, for example, a confidence threshold value. Block 46 may also provide conflict resolution, such as suggesting to conference users together that disagree or that want to discuss the predicted actions, automatically conferencing users together that disagree or that want to discuss the predicted actions, defaulting to a master user, defaulting to a voting system, and so on. Block 46 may, for example, default to a master user on an action-by-action basis, may default to a master user for all actions, and so on.

While independent blocks and/or a particular order has been shown for illustration purposes, it should be understood that one or more of the blocks of any of the method 38 may be combined, omitted, bypassed, re-arranged, and/or flow in any order.

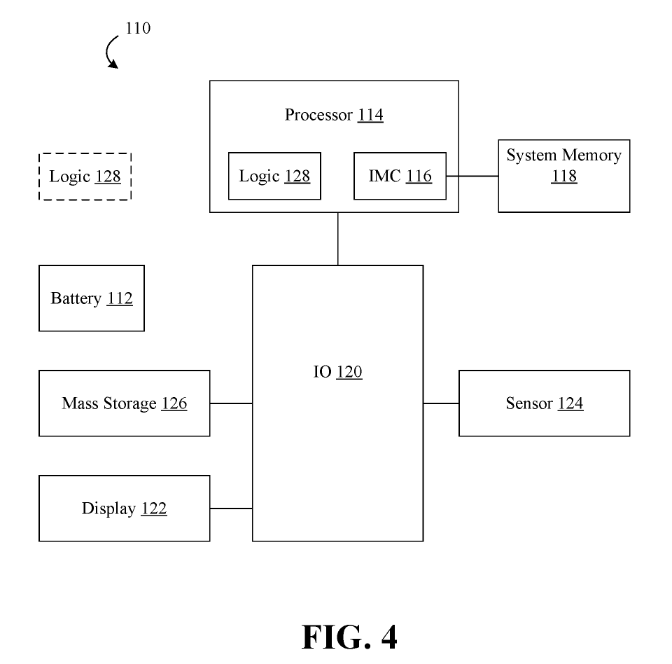

FIG. 4 shows a computing device 110 according to an embodiment. The computing device 110 may be part of a platform having computing functionality (e.g., personal digital assistant/PDA, notebook computer, tablet computer), communications functionality (e.g., wireless smart phone), imaging functionality, media playing functionality (e.g., smart television/TV), wearable functionality (e.g., watch, eyewear, headwear, footwear, jewelry) or any combination thereof (e.g., mobile Internet device/MID). In the illustrated example, the device 110 includes a battery 112 to supply power to the device 110 and a processor 114 having an integrated memory controller (IMC) 116, which may communicate with system memory 118. The system memory 118 may include, for example, dynamic random access memory (DRAM) configured as one or more memory modules such as, for example, dual inline memory modules (DIMMs), small outline DIMMs (SODIMMs), etc.

The illustrated device 110 also includes a input output (10) module 120, sometimes referred to as a Southbridge of a chipset, that functions as a host device and may communicate with, for example, a display 122 (e.g., touch screen, liquid crystal display/LCD, light emitting diode/LED display), a sensor 124 (e.g., touch sensor, accelerometer, GPS, etc.), and mass storage 126 (e.g., hard disk drive/HDD, optical disk, flash memory, etc.). The processor 114 and the IO module 120 may be implemented together on the same semiconductor die as a system on chip (SoC).

The illustrated processor 114 may execute logic 128 (e.g., logic instructions, configurable logic, fixed-functionality logic hardware, etc., or any combination thereof) configured to implement any of the herein mentioned processes and/or control assistance technologies, including one or more components of the system 10 (FIG. 1), one or more components of the apparatus 20 (FIG. 2), and/or one or more blocks of the method 38 (FIG. 3), discussed above. In addition, one or more aspects of the logic 128 may alternatively be implemented external to the processor 114.

### ADDITIONAL NOTES AND EXAMPLES

Example 1 may a system to provide control assistance comprising one or more of a mobile device on a user to provide sensor data for the user or a routine determiner to determine a routine based on one or more of the sensor data from the mobile device or sensor data from one or more indoor devices on a premises, and a control assistant to define an action of an indoor device based on one or more of the sensor data from the mobile device or the sensor data from the one or more indoor devices.

Example 2 may include the system of Example 1, further including a data collector to collect the sensor data from the mobile device, and collect the sensor data from the one or more indoor devices.

Example 3 may include the system of any one of Example 1 to Example 2, further including a predictor to generate a predicted action based on one or more of a current state of the user, a current state of the premises, or the routine, and one or more of a prompter to suggest the predicted action based on one or more of the current state of the user, the current state of the premises, or the routine, or an adjuster to automatically execute the predicted action based on one or more of the current state of the user, the current state of the premises, or the routine.

Example 4 may include the system of any one of Example 1 to Example 3, further including a sensor unit to aggregate sensor data from one or more of the mobile device, at least one other mobile device, or at least one indoor device on the premises, a control unit to aggregate control data that is to control at least one action of at least one indoor device on the premises, and an server unit to one or more of process sensor data from one or more of the sensor unit, the mobile device, the at least one other mobile device, or the at least one indoor device on the premises, or process control data from one or more of the control unit, the mobile device, or the at least one other mobile device.

Example 5 may include the apparatus to provide control assistance comprising a data collector to collect sensor data for a user from a mobile device on the user, and a control assistant to define an action of an indoor device on a premises based on the sensor data from the mobile device.

Example 6 may include the apparatus Example 5, wherein the mobile device is to include one of a mobile phone or a wearable device, and wherein the indoor device in to include an Internet of Things device.

Example 7 may include the apparatus of any one of Example 5 to Example 6, wherein the data collector is to collect outdoor sensor data for the user from the mobile device when the user is off the premises, and wherein the control assistant is to define the action of the indoor device based on the outdoor sensor data.

Example 8 may include the apparatus of any one of Example 5 to Example 7, wherein the data collector is to collect indoor sensor data for the user from the mobile device when the user is on the premises, and wherein the control assistant is to define the action of the indoor device based on the indoor sensor data.

Example 9 may include the apparatus of any one of Example 5 to Example 8, wherein the data collector is to collect sensor data for one or more of the user or the premises from one or more indoor devices on the premises, and wherein the control assistant is to define the action of the indoor device based on the sensor data from the one or more indoor devices.

Example 10 may include the apparatus of any one of Example 5 to Example 9, further including a routine determiner to determine a routine based on one or more of the sensor data for the user from the mobile device or sensor data from one or more indoor devices on the premises.

Example 11 may include the apparatus of any one of Example 5 to Example 10, wherein the routine determiner is to determine a plurality of routines for a plurality of users, and wherein the control assistant is to define the action of the indoor device based on the plurality of routines.

Example 12 may include the apparatus of any one of Example 5 to Example 11, wherein the data collector is to collect sensor data from a plurality of mobile devices on a plurality of users, and wherein the control assistant is to define the action of the indoor device based on the sensor data from the plurality of mobile devices.

Example 13 may include the apparatus of any one of Example 5 to Example 12, further including a predictor to generate a predicted action based on one or more of a current state of the user, a current state of the premises, or the routine, and one or more of a prompter to suggest the predicted action based on one or more of the current state of the user, the current state of the premises, or the routine, or an adjuster to automatically execute the predicted action based on one or more of the current state of the user, the current state of the premises, or the routine.

Example 14 may include at least one computer readable storage medium comprising a set of instructions, which when executed by a computer, cause the computer to collect sensor data for a user from a mobile device on the user, and define an action of an indoor device on a premises based on the sensor data from the mobile device.

Example 15 may include the at least one computer readable storage medium of Example 14, wherein the mobile device is to include one of a mobile phone or a wearable device, and wherein the indoor device in to include an Internet of Things device.

Example 16 may include the at least one computer readable storage medium of any one of Example 14 to Example 15, wherein the instructions, when executed, cause the computer to collect outdoor sensor data for the user from the mobile device when the user is off the premises, and define the action of the indoor device based on the outdoor sensor data.

Example 17 may include the at least one computer readable storage medium of any one of Example 14 to Example 16, wherein the instructions, when executed, cause the computer to collect indoor sensor data for the user from the mobile device when the user is on the premises, and define the action of the indoor device based on the indoor sensor data.

Example 18 may include the at least one computer readable storage medium of any one of Example 14 to Example 17, wherein the instructions, when executed, cause the computer to collect sensor data for one or more of the user or the premises from one or more indoor devices on the premises, and define the action of the indoor device based on the sensor data from the one or more indoor devices.

Example 19 may include the at least one computer readable storage medium of any one of Example 14 to Example 18, wherein the instructions, when executed, cause the computer to determine a routine based on one or more of the sensor data for the user from the mobile device or sensor data from one or more indoor devices on the premises.

Example 20 may include the at least one computer readable storage medium of any one of Example 14 to Example 19, wherein the instructions, when executed, cause the computer to determine a plurality of routines for a plurality of users, and define the action of the indoor device based on the plurality of routines.

Example 21 may include the at least one computer readable storage medium of any one of Example 14 to Example 20, wherein the instructions, when executed, cause the computer to collect sensor data from a plurality of mobile devices on a plurality of users, and define the action of the indoor device based on the sensor data from the plurality of mobile devices.

Example 22 may include the at least one computer readable storage medium of any one of Example 14 to Example 21, wherein the instructions, when executed, cause the computer to generate a predicted action based on one or more of a current state of the user, a current state of the premises, or the routine, and one or more of suggest the predicted action based on one or more of the current state of the user, the current state of the premises, or the routine, or automatically execute the predicted action based on one or more of the current state of the user, the current state of the premises, or the routine.

Example 23 may include a method to provide control assistance comprising collecting sensor data for a user from a mobile device on the user, and defining an action of an indoor device on a premises based on the sensor data from the mobile device.

Example 24 may include the method of Example 23, wherein the mobile device includes one of a mobile phone or a wearable device, and wherein the indoor device includes an Internet of Things device.

Example 25 may include the method of any one of Example 23 to Example 24, further including collecting outdoor sensor data for the user from the mobile device when the user is off the premises, and defining the action of the indoor device based on the outdoor sensor data.

Example 26 may include the method of any one of Example 23 to Example 25, further including collecting indoor sensor data for the user from the mobile device when the user is on the premises, and defining the action of the indoor device based on the indoor sensor data.

Example 27 may include the method of any one of Example 23 to Example 26, further including collecting sensor data for one or more of the user or the premises from one or more indoor devices on the premises, and defining the action of the indoor device based on the sensor data from the one or more indoor devices.

Example 28 may include the method of any one of Example 23 to Example 27, further including determining a routine based on one or more of the sensor data for the user from the mobile device or sensor data from one or more indoor devices on the premises.

Example 29 may include the method of any one of Example 23 to Example 28, further including determining a plurality of routines for a plurality of users, and defining the action of the indoor device based on the plurality of routines.

Example 30 may include the method of any one of Example 23 to Example 29, further including collecting sensor data from a plurality of mobile devices on a plurality of users, and defining the action of the indoor device based on the sensor data from the plurality of mobile devices.

Example 31 may include the method of any one of Example 23 to Example 30, further including generating a predicted action based on one or more of a current state of the user, a current state of the premises, or the routine, and one or more of suggesting the predicted action based on one or more of the current state of the user, the current state of the premises, or the routine, or automatically executing the predicted action based on one or more of the current state of the user, the current state of the premises, or the routine.

Example 32 may include an apparatus to provide control assistance comprising means for collecting sensor data for a user from a mobile device on the user, and means for defining an action of an indoor device on a premises based on the sensor data from the mobile device.

Example 33 may include the apparatus of Example 32, wherein the mobile device includes one of a mobile phone or a wearable device, and wherein the indoor device includes an Internet of Things device.

Example 34 may include the apparatus of any one of Example 32 to Example 33, further including means for collecting outdoor sensor data for the user from the mobile device when the user is off the premises, and means for defining the action of the indoor device based on the outdoor sensor data.

Example 35 may include the apparatus of any one of Example 32 to Example 34, further including means for collecting indoor sensor data for the user from the mobile device when the user is on the premises, and means for defining the action of the indoor device based on the indoor sensor data.

Example 36 may include the apparatus of any one of Example 32 to Example 35, further including means for collecting sensor data for one or more of the user or the premises from one or more indoor devices on the premises, and means for defining the action of the indoor device based on the sensor data from the one or more indoor devices.

Example 37 may include the apparatus of any one of Example 32 to Example 36, further including means for determining a routine based on one or more of the sensor data for the user from the mobile device or sensor data from one or more indoor devices on the premises.

Example 38 may include the apparatus of any one of Example 32 to Example 37, further including means for determining a plurality of routines for a plurality of users, and means for defining the action of the indoor device based on the plurality of routines.

Example 39 may include the apparatus of any one of Example 32 to Example 38, further including means for collecting sensor data from a plurality of mobile devices on a plurality of users, and means for defining the action of the indoor device based on the sensor data from the plurality of mobile devices.

Example 40 may include the apparatus of any one of Example 32 to Example 39, further including means for generating a predicted action based on one or more of a current state of the user, a current state of the premises, or the routine; and one or more of means for suggesting the predicted action based on one or more of the current state of the user, the current state of the premises, or the routine, or means for automatically executing the predicted action based on one or more of the current state of the user, the current state of the premises, or the routine.

Thus, techniques described herein may utilize mobile devices that are not required to be fixed in a particular location, permanently or while operating, to generate sensor data. In addition, the sensor data may be specific to users associated with specific mobile devices. Moreover, the sensor data may be specific to a context of specific users, inside or outside of premises, including current activities and/or routines. Also, sensor data may be provided for a plurality of users. Embodiments may, therefore, use advanced learning methods to proactively predict most probable actions for indoor devices based on sensor data.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so forth” or “etc.” may mean any combination of the listed terms as well any combination with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
one or more of,
a mobile device on a user to provide sensor data for the user, or
a routine determiner to determine a routine based on one or more of the sensor data from the mobile device or sensor data from one or more indoor devices on a premises, and
a control assistant to define an action of an indoor device based on one or more of the sensor data from the mobile device or the sensor data from the one or more indoor devices.

2. The system of claim 1, further including a data collector to,
collect the sensor data from the mobile device, and
collect the sensor data from the one or more indoor devices.

3. The system of claim 1, further including,
a predictor to generate a predicted action based on one or more of a current state of the user, a current state of the premises, or the routine, and
one or more of,
a prompter to suggest the predicted action based on one or more of the current state of the user, the current state of the premises, or the routine, or
an adjuster to automatically execute the predicted action based on one or more of the current state of the user, the current state of the premises, or the routine.

4. The system of claim 1, further including,
a sensor unit to aggregate sensor data from one or more of the mobile device, at least one other mobile device, or at least one indoor device on the premises,
a control unit to aggregate control data that is to control at least one action of at least one indoor device on the premises, and
an server unit to one or more of,
process sensor data from one or more of the sensor unit, the mobile device, the at least one other mobile device, or the at least one indoor device on the premises, or
process control data from one or more of the control unit, the mobile device, or the at least one other mobile device.

5. An apparatus comprising:
a data collector to collect sensor data for a user from a mobile device on the user, and
a control assistant to define an action of an indoor device on a premises based on the sensor data from the mobile device.

6. The apparatus of claim 5, wherein the mobile device is to include one of a mobile phone or a wearable device, and wherein the indoor device in to include an Internet of Things device.

7. The apparatus of claim 5, wherein the data collector is to collect outdoor sensor data for the user from the mobile device when the user is off the premises, and wherein the control assistant is to define the action of the indoor device based on the outdoor sensor data.

8. The apparatus of claim 5, wherein the data collector is to collect indoor sensor data for the user from the mobile device when the user is on the premises, and wherein the control assistant is to define the action of the indoor device based on the indoor sensor data.

9. The apparatus of claim 5, wherein the data collector is to collect sensor data for one or more of the user or the premises from one or more indoor devices on the premises, and wherein the control assistant is to define the action of the indoor device based on the sensor data from the one or more indoor devices.

10. The apparatus of claim 5, further including a routine determiner to determine a routine based on one or more of the sensor data for the user from the mobile device or sensor data from one or more indoor devices on the premises.

11. The apparatus of claim 10, wherein the routine determiner is to determine a plurality of routines for a plurality of users, and wherein the control assistant is to define the action of the indoor device based on the plurality of routines.

12. The apparatus of claim 5, wherein the data collector is to collect sensor data from a plurality of mobile devices on a plurality of users, and wherein the control assistant is to define the action of the indoor device based on the sensor data from the plurality of mobile devices.

13. The apparatus of any claim 5, further including,
a predictor to generate a predicted action based on one or more of a current state of the user, a current state of the premises, or the routine, and
one or more of,
a prompter to suggest the predicted action based on one or more of the current state of the user, the current state of the premises, or the routine, or
an adjuster to automatically execute the predicted action based on one or more of the current state of the user, the current state of the premises, or the routine.

14. At least one computer readable storage medium comprising a set of instructions, which when executed by a computer, cause the computer to:
collect sensor data for a user from a mobile device on the user; and
define an action of an indoor device on a premises based on the sensor data from the mobile device.

15. The at least one computer readable storage medium of claim 14, wherein the instructions, when executed, cause the computer to:
collect one or more of outdoor sensor data for the user from the mobile device when the user is off the premises, indoor sensor data for the user from the mobile device when the user is on the premises, or sensor data for one or more of the user or the premises from one or more indoor devices on the premises; and
define the action of the indoor device based on one or more of the outdoor sensor data, the indoor sensor data, or the sensor data from the one or more indoor devices.

16. The at least one computer readable storage medium of claim 14, wherein the instructions, when executed, cause the computer to determine a routine based on one or more of the sensor data for the user from the mobile device or sensor data from one or more indoor devices on the premises.

17. The at least one computer readable storage medium of claim 16, wherein the instructions, when executed, cause the computer to:
determine a plurality of routines for a plurality of users; and
define the action of the indoor device based on the plurality of routines.

18. The at least one computer readable storage medium of claim 14, wherein the instructions, when executed, cause the computer to:
collect sensor data from a plurality of mobile devices on a plurality of users; and
define the action of the indoor device based on the sensor data from the plurality of mobile devices.

19. The at least one computer readable storage medium claim 14, wherein the instructions, when executed, cause the computer to:
generate a predicted action based on one or more of a current state of the user, a current state of the premises, or the routine; and
one or more of:
suggest the predicted action based on one or more of the current state of the user, the current state of the premises, or the routine; or
automatically execute the predicted action based on one or more of the current state of the user, the current state of the premises, or the routine.

20. A method comprising:
collecting sensor data for a user from a mobile device on the user; and
defining an action of an indoor device on a premises based on the sensor data from the mobile device.

21. The method of claim 20, further including:
collecting one or more of outdoor sensor data for the user from the mobile device when the user is off the premises, indoor sensor data for the user from the mobile device when the user is on the premises, or sensor data for one or more of the user or the premises from one or more indoor devices on the premises; and
defining the action of the indoor device based on one or more of the outdoor sensor data, the indoor sensor data, or the sensor data from the one or more indoor devices.

22. The method of claim 20, further including determining a routine based on one or more of the sensor data for the user from the mobile device or sensor data from one or more indoor devices on the premises.

23. The method of claim 23, further including:
determining a plurality of routines for a plurality of users; and
defining the action of the indoor device based on the plurality of routines.

24. The method of claim 20, further including:
collecting sensor data from a plurality of mobile devices on a plurality of users; and
defining the action of the indoor device based on the sensor data from the plurality of mobile devices.

25. The method of claim 20, further including:
generating a predicted action based on one or more of a current state of the user, a current state of the premises, or the routine; and
one or more of:
suggesting the predicted action based on one or more of the current state of the user, the current state of the premises, or the routine; or
automatically executing the predicted action based on one or more of the current state of the user, the current state of the premises, or the routine.
